(19) United States
(12) Patent Application Publication
(10) Pub. No.: US 2009/0318210 A1
(43) Pub. Date: Dec. 24, 2009

(54) POKER GAME PLAYING METHOD

(76) Inventor: Luis F. De La Pena, Bogota (CO)

Correspondence Address: JOHN J. MARTINEZ MD. JD., 10 PALMER AVENUE, CROTON ON HUDSON, NY, 10520, US

(21) Appl. No.: 12/143,777

(22) Filed: Jun. 21, 2008

(51) Int. Cl. A63F 13/00; A63F 1/00

(52) U.S. Cl. 463/13; 273/292

(57) ABSTRACT

The present invention provides a poker game playing method wherein multiple five-card hands from once previously shuffled 52-card poker deck can be played without increasing probabilities against a casino, while maintaining maximum entertainment value, and with immediate certainty of winning or losing. The method of the present invention maximizes entertainment value derived from said poker deck by rewarding a gambler with free five-card hands when there had been five-card hand winning combinations, wherein the rewarding free five-card hands are from the remaining un-played cards of said same poker deck, thus, without increasing chances against a casino or gaming house, and wherein a gambler may have a false impression of increased probabilities in his favor because of the rewarding free five-card hands, therefore increasing his gambling desire to start anew waging against newly shuffled 52-card poker decks.

### BACKGROUND OF THE INVENTION

1. Field of the Present Invention

The field of the present invention relates to a method of playing a poker game wherein a 52-card deck entertainment value is maximized without increasing the probabilities against a gaming house or casino.

2. Description of the Prior Art

Ways or methods to play a poker game are many. However, there is no description of playing multiple five-card hands from just one previously shuffled 52-card poker deck, wherein the probabilities against a casino do not increase, while maintaining maximum entertainment value.

By way of example, U.S. Pat. No. 6,638,163 to Moody describes a poker game that start with a poker deck, and an incentive component derived from a complete newly shuffled poker deck, thus, renewing or duplicating the gambler probabilities against a casino. Other examples are U.S. Patent Application No. 20060267283A1 by Jackson, U.S. Pat. No. 5,908,353 to Andrews, U.S. Pat. No. 5,845,907 to Wells, U.S. Patent Application No. 20060157936A1 by Moody, U.S. Pat. No. 6,131,907 to Nucifora, etc.

The present invention provides a poker game playing method that overcomes the mentioned limitations of the prior art.

### SUMMARY OF THE INVENTION

The present invention provides a poker game playing method wherein multiple five-card hands from once previously shuffled 52-card poker deck can be played without increasing probabilities against a casino, while maintaining maximum entertainment value, and with immediate certainty of winning or losing. The method of the present invention maximizes entertainment value derived from said poker deck by rewarding a gambler with free five-card hands when there had been five-card hand winning combinations, wherein the rewarding free five-card hands are from the remaining un-played cards of said same poker deck, thus, without increasing chances against a casino or gaming house, and wherein a gambler may have a false impression of increased probabilities in his favor because of the rewarding free five-card hands, therefore increasing his gambling desire to start anew waging against newly shuffled 52-card poker decks.

More specifically, the present invention provides a method of playing a poker game on a table, wherein the method comprises:
A) A player starting a game by making wagers to play a facedown five-card hand from a once previously shuffled 52-card poker deck, wherein the player can play between one and ten facedown five-card hands from said same 52-card poker deck, wherein the player makes a wager for each facedown five-card hand, and wherein the wager for a facedown five-card hand can be different from the wagers for the other facedown five-hand cards;
B) A dealer Dealing to the player between one and ten facedown five-card hands from said same 52-card poker deck;
C) Opening the five-card hands from said same 52-card poker deck;
D) Determining the poker hand ranking of each one of the five-card hands;
E) If any of the five-card hands is a winning combination, awarding the player a pre-established winning amount based on the amount of the wager for each five-card hand;

wherein, if any of the five-card hands is a winning combination and if there are remaining cards from said same poker deck, rewarding to the player another five card hand for each winning combination, wherein the remaining cards from said same deck could be 47 if one initial five-card hand was played, 42 if two initial five-card hands were played, 37 if three initial five-card hands were played, 32 if four initial five-card hands were played, 27 if five initial five-card hands were played, 22 if six initial five-card hands were played; 17 if seven initial five-card hands were played; 12 if eight initial five-card hands were played; 7 if nine initial five-card hands were played, wherein if there are less number of remaining cards than the cards needed to reward several concomitant winning combination the player is rewarded with just the maximum possible five-card hands from the remaining cards based on which winning combinations have the highest ranking, wherein if there is a rewarding five-card hand winning combination, the player is rewarded according to a a pre-established winning amount based on the amount of the original wager for the original five-card hand, wherein the game is over when there are no winning combinations; and wherein the game is also over when there are just two remaining cards from said same card deck.

In one aspect of the method of the present invention, more than one player participate in the game, wherein the game starts when there is wagers for at least two facedown five-card hands from the same 52-card poker deck, wherein more than one player make wagers to play between two and ten concurrent facedown five-card hands from the same 52-card poker deck, wherein there is a wager for each facedown five-card hand from the same 52-card poker game, and wherein the wager for a facedown five-card hand can be different from the wagers for the other facedown five-hand cards.

In another aspect of the method of the present invention, the rewarding five card-hands are taken from the remaining cards of said same poker deck, wherein the remaining cards of said same poker deck are not shuffled anymore.

In one embodiment of the method of the present invention, the five-card hands from the same 52-card poker deck are opened.

In another embodiment of the method of the present invention, the poker game can be played on a gaming machine with a video screen, wherein the gaming machine is programmed to assume the role of the dealer.

In one more embodiment, the present invention is a method of playing a poker game on a gaming machine with a video screen, wherein the method comprises:
A. A player activating a game in the gaming machine by making wagers for five-card hands from a previously shuffled 52-card poker deck, wherein the player can play between one and five five-card hands from the same 52-card poker deck, and wherein the player makes a wager for each five-card hand, and wherein the wager for a five-card hand can be different from the wagers for the other five-hand cards;
B. The gaming machine dealing on the video-screen between one and five five-card hands from the same 52-card poker deck;
C. Determining the poker hand ranking of each one of the five-card hands;
D. If any of the five-card hands is a winning combination, awarding the player a pre-established winning amount based on the amount of the wager for each five-card hand;
E. The machine dealing, as incentive, only for each five-card winning combination, another five-card hand from the remaining cards of said same original poker deck;
F. If any of the latest dealt-as-incentive five-card hands is a winning combination, awarding the player a pre-established winning amount based on the amount of the original wager for the corresponding original five-card hand;
G. If there is available a five-card hand from the same original poker deck, and if there is a five-card winning combination, steps E. and F. are repeated successively until the game ends;

wherein, the game ends when there are no more available five-card hands from the remaining cards of said same original poker deck. In another version of this embodiment of the present invention, the poker game is played on a table and the five-card hands are dealt by a dealer.

In a further embodiment of the present invention is a method of playing a poker game on a table, wherein the method comprises:
A) A player starting a game by making wagers to play at least two facedown five-card hands from the same 52-card poker deck, wherein the player can play between two and ten facedown five-card hands from the same 52-card poker deck, wherein the player makes a wager for each facedown five-card hand, and wherein the wager for a facedown five-card hand can be different from the wagers for the other facedown five-hand cards;
B) A dealer Dealing to the player between two and ten facedown five-card hands from the same 52-card poker deck;
C) Opening the five-card hands from the same 52-card poker deck;
D) Determining the poker hand ranking of each one of the five-card hands; and,
E) If any of the five-card hands is a winning combination, awarding the player a pre-established winning amount based on the amount of the wager for each five-card hand.

wherein, if any of the five-card hands is a winning combination and if there are remaining cards from said same poker deck, rewarding to the player another five card hand for each winning combination, wherein the remaining cards from said same deck could be 47 if one initial five-card hand was played, 42 if two initial five-card hands were played, 37 if three initial five-card hands were played, 32 if four initial five-card hands were played, 27 if five initial five-card hands were played, 22 if six initial five-card hands were played; 17 if seven initial five-card hands were played; 12 if eight initial five-card hands were played; 7 if nine initial five-card hands were played, wherein if there are less number of remaining cards than the cards needed to reward several concomitant winning combination the player is rewarded with just the maximum possible five-card hands from the remaining cards based on which winning combinations have the highest ranking, wherein if there is a rewarding five-card hand winning combination, the player is rewarded according to a a pre-established winning amount based on the amount of the original wager for the original five-card hand, wherein the game is over when there are no winning combinations; and wherein the game is also over when there are just two remaining cards from said same card deck. In another version of this embodiment of the present invention, more than one player may participate in the game, and the game starts when there is wagers for at least two facedown five-card hands from the same 52-card poker deck, wherein more than one player make wagers to play between two and ten concurrent facedown five-card hands from the same 52-card poker deck, wherein there is a wager for each facedown five-card hand from the same 52-card poker game, and wherein the wager for a facedown five-card hand can be different from the wagers for the other facedown five-hand cards. Yet, in one more version of this embodiment of the method of the present invention, the five-card hands from the same 52-card poker deck are opened. Even more, in a further version of this embodiment of the method present invention, the poker game can be played on a gaming machine with a video screen.

In one more embodiment, the present invention is a method of playing a game on a gaming machine with a video screen, wherein the method comprises:
A. A player activating a game in the gaming machine by making wagers for at least two five-card hands from the same 52-card poker deck, wherein the player can play between two and five five-card hands from the same 52-card poker deck, and wherein the player makes a wager for each five-card hand, and wherein the wager for a five-card hand can be different from the wagers for the other five-hand cards;
B. The gaming machine dealing on the video-screen between two and five five-card hands from the same 52-card poker deck;
C. Determining the poker hand ranking of each one of the five-card hands;
D. If any of the five-card hands is a winning combination, awarding the player a pre-established winning amount based on the amount of the wager for each five-card hand;
E. The machine dealing, as incentive, only for each five-card winning combination, another five-card hand from the same original 52-card poker deck;
F. If any of the latest dealt five-card hands is a winning combination, awarding the player a pre-established winning amount based on the amount of the original wager for the corresponding original five-card hand;
G. If there is available a five-card hand from the same original 52-card poker deck, and if there is a five-card winning combination, steps E. and F. are repeated successively until the game ends;

wherein, the game ends when there are no more available five-card hands from the same original 52-card poker deck. Yet, in another version of this embodiment of the present invention, the game is played on a table and the five-card hands are dealt by a dealer.

Objectives and additional advantages of the present invention will become more evident in the description of the figures, the detailed description of the invention and the claims.

### BRIEF DESCRIPTION OF THE DRAWINGS

FIG. 1 shows a gaming table where the poker game can be played applying the method of the present invention, wherein the table is configured for up to seven five-card hands from a previously shuffled 52-card poker deck.

FIG. 2 shows the ranking table for five-card hand winning combinations.

### DETAILED DESCRIPTION OF THE INVENTION

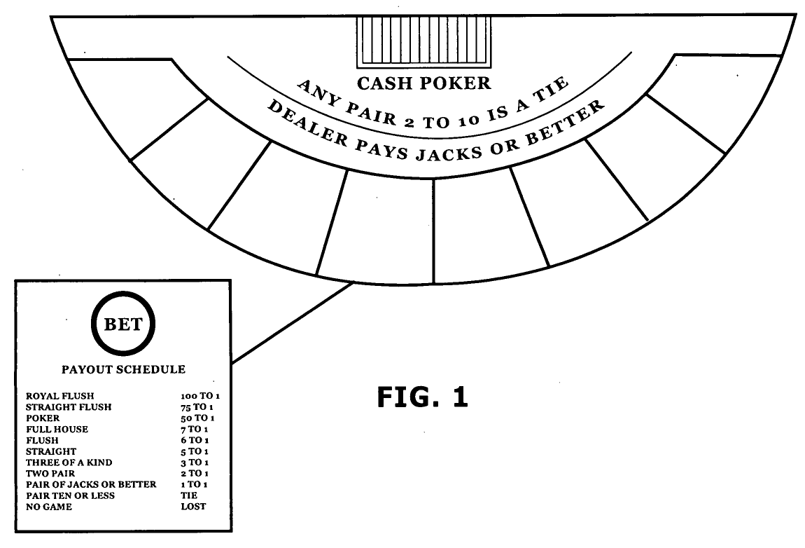

FIG. 1 shows a gaming table where the poker game can be played applying the method of the present invention. Although in FIG. 1, the gaming table is configured for 7 five-card winning combinations out of one previously shuffled 52-card poker deck, in other embodiments of the present invention, the table can be configured for up to 5, for up to 10, etc. five-card hands from a previously shuffled 52-card poker deck.

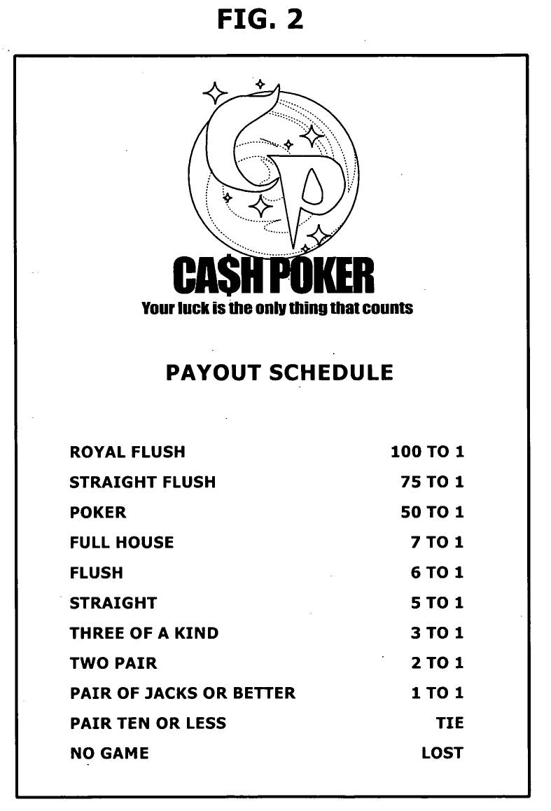

FIG. 2 shows the preferred ranking table for five-card hand winning combinations. However, other ranking tables can be used for five-card hand winning combinations.

In no case, a pair is a defined under this application as a winning combination. A pair is a tie, which entitles the player reimbursement of the wage, but a pair DO NOT mean that the player receives as incentive an additional rewarding free five-card hand from the remaining cards of the same poker deck from which the original five-card hand wage was made. In contrast, as explained below, a five-card winning combination results in a free rewarding five-card hand if there are available cards from the same poker deck from which the original five-card hand wage was made. By defining a pair as a tie, a gambler stays motivated to keep playing by making new wages against new previously shuffled 52-card poker decks; and by not defining a pair as a winning combination, probabilities against the casino do not increase. In other words, the method of the present invention maintains the motivation of the gambler without increasing odds against a gaming house or casino.

TABLE 1

| Hand | Frequency | Probability | Cumulative | Odds |
|---|---|---|---|---|
| Straight | 40 | 0.00154% | 0.00154% | 64,973:1 |
| flush | | | | |
| Four of a | 624 | 0.0240% | 0.0256% | 4,164:1 |
| kind | | | | |
| Full house | 3,744 | 0.144% | 0.170% | 693:1 |
| Flush | 5,108 | 0.197% | 0.367% | 508:1 |
| Straight | 10,200 | 0.392% | 0.76% | 254:1 |
| Three of a | 54,912 | 2.11% | 2.87% | 46.3:1 |
| kind | | | | |
| Two pair | 123,552 | 4.75% | 7.62% | 20.0:1 |
| One pair | 1,098,240 | 42.3% | 49.9% | 1.37:1 |
| No pair | 1,302,540 | 50.1% | 100% | 0.995:1 |
| Total | 2,598,960 | 100% | 100% | 0:1 |

Table 1 enumerates the frequency of each hand, given all combinations of five-card hands randomly drawn from a full deck of 52 without replacement. Wild cards are not considered. The probability of drawing a given hand is calculated by dividing the number of ways of drawing the hand by the total number of 5-card hands (the sample space, (₅⁵²)=2,598,960 five-card hands). The odds are defined as the ratio (1/p)-1:1, where p is the probability. (The frequencies given are exact; the probabilities and odds are approximate.) Once cards are drawn from a 52-card poker deck, the probabilities of a five-card hand winning combination diminish for the un-drawn remaining cards of the same deck due to the effect of retiring drawn cards from the deck, wherein said retired cards are no more available to be part of a possible winning combination.

The method of the present invention specifically provides a method of playing a poker game on a table, wherein the method comprises:
A) A player starting a game by making wagers to play a facedown five-card hand from a once previously shuffled 52-card poker deck, wherein the player can play between one and ten facedown five-card hands from said same 52-card poker deck, wherein the player makes a wager for each facedown five-card hand, and wherein the wager for a facedown five-card hand can be different from the wagers for the other facedown five-hand cards;
B) A dealer Dealing to the player between one and ten facedown five-card hands from said same 52-card poker deck;
C) Opening the five-card hands from said same 52-card poker deck;
D) Determining the poker hand ranking of each one of the five-card hands;
E) If any of the five-card hands is a winning combination, awarding the player a pre-established winning amount based on the amount of the wager for each five-card hand;

wherein, if any of the five-card hands is a winning combination and if there are remaining cards from said same poker deck, rewarding to the player another five card hand for each winning combination, wherein the remaining cards from said same deck could be 47 if one initial five-card hand was played, 42 if two initial five-card hands were played, 37 if three initial five-card hands were played, 32 if four initial five-card hands were played, 27 if five initial five-card hands were played, 22 if six initial five-card hands were played; 17 if seven initial five-card hands were played; 12 if eight initial five-card hands were played; 7 if nine initial five-card hands were played, wherein if there are less number of remaining cards than the cards needed to reward several concomitant winning combination the player is rewarded with just the maximum possible five-card hands from the remaining cards based on which winning combinations have the highest ranking, wherein if there is a rewarding five-card hand winning combination, the player is rewarded according to a a pre-established winning amount based on the amount of the original wager for the original five-card hand, wherein the game is over when there are no winning combinations; and wherein the game is also over when there are just two remaining cards from said same card deck.

In one aspect of the method of the present invention, more than one player participate in the game, wherein the game starts when there is wagers for at least two facedown five-card hands from the same 52-card poker deck, wherein more than one player make wagers to play between two and ten concurrent facedown five-card hands from the same 52-card poker deck, wherein there is a wager for each facedown five-card hand from the same 52-card poker game, and wherein the wager for a facedown five-card hand can be different from the wagers for the other facedown five-hand cards.

In another aspect of the method of the present invention, the rewarding five card-hands are taken from the remaining cards of said same poker deck, wherein the remaining cards of said same poker deck are not shuffled anymore.

In one embodiment of the method of the present invention, the five-card hands from the same 52-card poker deck are opened.

In another embodiment of the method of the present invention, the poker game can be played on a gaming machine with a video screen, wherein the gaming machine is programmed to assume the role of the dealer.

In one more embodiment, the present invention is a method of playing a poker game on a gaming machine with a video screen, wherein the method comprises:
A. A player activating a game in the gaming machine by making wagers for five-card hands from a previously shuffled 52-card poker deck, wherein the player can play between one and five five-card hands from the same 52-card poker deck, and wherein the player makes a wager for each five-card hand, and wherein the wager for a five-card hand can be different from the wagers for the other five-hand cards;
B. The gaming machine dealing on the video-screen between one and five five-card hands from the same 52-card poker deck;
C. Determining the poker hand ranking of each one of the five-card hands;
D. If any of the five-card hands is a winning combination, awarding the player a pre-established winning amount based on the amount of the wager for each five-card hand;
E. The machine dealing, as incentive, only for each five-card winning combination, another five-card hand from the remaining cards of said same original poker deck;
F. If any of the latest dealt-as-incentive five-card hands is a winning combination, awarding the player a pre-established winning amount based on the amount of the original wager for the corresponding original five-card hand;
G. If there is available a five-card hand from the same original poker deck, and if there is a five-card winning combination, steps E. and F. are repeated successively until the game ends;

wherein, the game ends when there are no more available five-card hands from the remaining cards of said same original poker deck. In another version of this embodiment of the present invention, the poker game is played on a table and the five-card hands are dealt by a dealer.

In a further embodiment of the present invention is a method of playing a poker game on a table, wherein the method comprises:
A) A player starting a game by making wagers to play at least two facedown five-card hands from the same 52-card poker deck, wherein the player can play between two and ten facedown five-card hands from the same 52-card poker deck, wherein the player makes a wager for each facedown five-card hand, and wherein the wager for a facedown five-card hand can be different from the wagers for the other facedown five-hand cards;
B) A dealer Dealing to the player between two and ten facedown five-card hands from the same 52-card poker deck;
C) Opening the five-card hands from the same 52-card poker deck;
D) Determining the poker hand ranking of each one of the five-card hands; and,
E) If any of the five-card hands is a winning combination, awarding the player a pre-established winning amount based on the amount of the wager for each five-card hand.

wherein, if any of the five-card hands is a winning combination and if there are remaining cards from said same poker deck, rewarding to the player another five card hand for each winning combination, wherein the remaining cards from said same deck could be 47 if one initial five-card hand was played, 42 if two initial five-card hands were played, 37 if three initial five-card hands were played, 32 if four initial five-card hands were played, 27 if five initial five-card hands were played, 22 if six initial five-card hands were played; 17 if seven initial five-card hands were played; 12 if eight initial five-card hands were played; 7 if nine initial five-card hands were played, wherein if there are less number of remaining cards than the cards needed to reward several concomitant winning combination the player is rewarded with just the maximum possible five-card hands from the remaining cards based on which winning combinations have the highest ranking, wherein if there is a rewarding five-card hand winning combination, the player is rewarded according to a a pre-established winning amount based on the amount of the original wager for the original five-card hand, wherein the game is over when there are no winning combinations; and wherein the game is also over when there are just two remaining cards from said same card deck. In another version of this embodiment of the present invention, more than one player may participate in the game, and the game starts when there is wagers for at least two facedown five-card hands from the same 52-card poker deck, wherein more than one player make wagers to play between two and ten concurrent facedown five-card hands from the same 52-card poker deck, wherein there is a wager for each facedown five-card hand from the same 52-card poker game, and wherein the wager for a facedown five-card hand can be different from the wagers for the other facedown five-hand cards. Yet, in one more version of this embodiment of the method of the present invention, the five-card hands from the same 52-card poker deck are opened. Even more, in a further version of this embodiment of the method present invention, the poker game can be played on a gaming machine with a video screen.

In one more embodiment, the present invention is a method of playing a game on a gaming machine with a video screen, wherein the method comprises:
A. A player activating a game in the gaming machine by making wagers for at least two five-card hands from the same 52-card poker deck, wherein the player can play between two and five five-card hands from the same 52-card poker deck, and wherein the player makes a wager for each five-card hand, and wherein the wager for a five-card hand can be different from the wagers for the other five-hand cards;
B. The gaming machine dealing on the video-screen between two and five five-card hands from the same 52-card poker deck;
C. Determining the poker hand ranking of each one of the five-card hands;
D. If any of the five-card hands is a winning combination, awarding the player a pre-established winning amount based on the amount of the wager for each five-card hand;
E. The machine dealing, as incentive, only for each five-card winning combination, another five-card hand from the same original 52-card poker deck;
F. If any of the latest dealt five-card hands is a winning combination, awarding the player a pre-established winning amount based on the amount of the original wager for the corresponding original five-card hand;
G. If there is available a five-card hand from the same original 52-card poker deck, and if there is a five-card winning combination, steps E. and F. are repeated successively until the game ends;

wherein, the game ends when there are no more available five-card hands from the same original 52-card poker deck. Yet, in another version of this embodiment of the present invention, the game is played on a table and the five-card hands are dealt by a dealer.

In all possible embodiments of the present invention, it is possible that after multiple initial five-card hand wages from one previously shuffled 52-card poker deck, there is more five-card hands showing winning combinations, than remaining cards from the same deck to reward the five card winning combinations. For example, there may be 6 five card hands showing winning combinations, and in just 22 cards remaining from the same deck that will produce only 4 free rewarding five-card hands. In the example, the method of the present invention rule is to reward the 4 five-card hand winning combinations with the highest ranking, and the game is over. In other words, when there is more five-card hands showing winning combinations than rewarding free five-card hands possible out of the remaining cards left on the poker deck, only the highest five-card hand winning combinations will be rewarded with the possible free five-card hands left on the remaining cards of the same poker deck, and the game will be over. In this way, there is no possibility that the probabilities against a casino or gaming house are renewed by rewarding a gambler with new hands from another 52-card poker deck.

While the description presents the preferred embodiments of the present invention, additional changes can be made in the form and disposition of the parts without distancing from the basic ideas and principles comprised in the claims.

1. A method of playing a poker game on a table, wherein the method comprises:
A) A player starting a game by making wagers to play a facedown five-card hand from a once previously shuffled 52-card poker deck, wherein the player can play between one and ten facedown five-card hands from said same 52-card poker deck, wherein the player makes a wager for each facedown five-card hand, and wherein the wager for a facedown five-card hand can be different from the wagers for the other facedown five-hand cards;
B) A dealer Dealing to the player between one and ten facedown five-card hands from said same 52-card poker deck;
C) Opening the five-card hands from said same 52-card poker deck;
D) Determining the poker hand ranking of each one of the five-card hands;
E) If any of the five-card hands is a winning combination, awarding the player a pre-established winning amount based on the amount of the wager for each five-card hand;
and wherein, if any of the five-card hands is a winning combination and if there are remaining cards from said same poker deck, rewarding to the player another five card hand for each winning combination, wherein the remaining cards from said same deck could be 47 if one initial five-card hand was played, 42 if two initial five-card hands were played, 37 if three initial five-card hands were played, 32 if four initial five-card hands were played, 27 if five initial five-card hands were played, 22 if six initial five-card hands were played; 17 if seven initial five-card hands were played; 12 if eight initial five-card hands were played; 7 if nine initial five-card hands were played, wherein if there are less number of remaining cards than the cards needed to reward several concomitant winning combination the player is rewarded with just the maximum possible five-card hands from the remaining cards based on which winning combinations have the highest ranking, wherein if there is a rewarding five-card hand winning combination, the player is rewarded according to a a pre-established winning amount based on the amount of the original wager for the original five-card hand, wherein the game is over when there are no winning combinations; and wherein the game is also over when there are just two remaining cards from said same card deck.

2. The method of claim 1, wherein more than one player participate in the game, wherein the game starts when there is wagers for at least two facedown five-card hands from the same 52-card poker deck, wherein more than one player make wagers to play between two and ten concurrent facedown five-card hands from the same 52-card poker deck, wherein there is a wager for each facedown five-card hand from the same 52-card poker game, and wherein the wager for a facedown five-card hand can be different from the wagers for the other facedown five-hand cards.

3. The method of claim 1, wherein the rewarding five card-hands are taken from the no more shuffled remaining cards of said same poker deck.

4. The method of claim 1, wherein the five-card hands from the same 52-card poker deck are opened.

5. The method of claim 1, wherein the game can be played on a gaming machine with a video screen, wherein the gaming machine is programmed to assume the role of the dealer.

6. A method of playing a game on a gaming machine with a video screen, wherein the method comprises:
A. A player activating a game in the gaming machine by making wagers for five-card hands from a previously shuffled 52-card poker deck, wherein the player can play between one and five five-card hands from the same 52-card poker deck, and wherein the player makes a wager for each five-card hand, and wherein the wager for a five-card hand can be different from the wagers for the other five-hand cards;
B. The gaming machine dealing on the video-screen between one and five five-card hands from the same 52-card poker deck;
C. Determining the poker hand ranking of each one of the five-card hands;
D. If any of the five-card hands is a winning combination, awarding the player a pre-established winning amount based on the amount of the wager for each five-card hand;
E. The machine dealing, as incentive, only for each five-card winning combination, another five-card hand from the remaining cards of said same original poker deck;
F. If any of the latest dealt-as-incentive five-card hands is a winning combination, awarding the player a pre-established winning amount based on the amount of the original wager for the corresponding original five-card hand;
G. If there is available a five-card hand from the same original 52-card poker deck, and if there is a five-card winning combination, steps E. and F. are repeated successively until the game ends;
Wherein, the game ends when there are no more available five-card hands from the remaining cards of said same original poker deck.

7. The method of claim 6, wherein the game is played on a table and the five-card hands are dealt by a dealer.

8. A method of playing a poker game on a table, wherein the method comprises:
A) A player starting a game by making wagers to play at least two facedown five-card hands from the same 52-card poker deck, wherein the player can play between two and ten facedown five-card hands from the same 52-card poker deck, wherein the player makes a wager for each facedown five-card hand, and wherein the wager for a facedown five-card hand can be different from the wagers for the other facedown five-hand cards;
B) A dealer Dealing to the player between two and ten facedown five-card hands from the same 52-card poker deck;
C) Opening the five-card hands from the same 52-card poker deck;
D) Determining the poker hand ranking of each one of the five-card hands;
E) If any of the five-card hands is a winning combination, awarding the player a pre-established winning amount based on the amount of the wager for each five-card hand;
and wherein, if any of the five-card hands is a winning combination and if there are remaining cards from said same poker deck, rewarding to the player another five card hand for each winning combination, wherein the remaining cards from said same deck could be 47 if one initial five-card hand was played, 42 if two initial five-card hands were played, 37 if three initial five-card hands were played, 32 if four initial five-card hands were played, 27 if five initial five-card hands were played, 22 if six initial five-card hands were played; 17 if seven initial five-card hands were played; 12 if eight initial five-card hands were played; 7 if nine initial five-card hands were played, wherein if there are less number of remaining cards than the cards needed to reward several concomitant winning combination the player is rewarded with just the maximum possible five-card hands from the remaining cards based on which winning combinations have the highest ranking, wherein if there is a rewarding five-card hand winning combination, the player is rewarded according to a a pre-established winning amount based on the amount of the original wager for the original five-card hand, wherein the game is over when there are no winning combinations; and wherein the game is also over when there are just two remaining cards from said same card deck.

9. The method of claim 8, wherein more than one player participate in the game, wherein the game starts when there is wagers for at least two facedown five-card hands from the same 52-card poker deck, wherein more than one player make wagers to play between two and ten concurrent facedown five-card hands from the same 52-card poker deck, wherein there is a wager for each facedown five-card hand from the same 52-card poker game, and wherein the wager for a facedown five-card hand can be different from the wagers for the other facedown five-hand cards.

10. The method of claim 8, wherein the five-card hands from the same 52-card poker deck are opened.

11. The method of claim 8, wherein the game can be played on a gaming machine with a video screen.

12. A method of playing a game on a gaming machine with a video screen, wherein the method comprises:
A. A player activating a game in the gaming machine by making wagers for at least two five-card hands from the same 52-card poker deck, wherein the player can play between two and five five-card hands from the same 52-card poker deck, and wherein the player makes a wager for each five-card hand, and wherein the wager for a five-card hand can be different from the wagers for the other five-hand cards;
B. The gaming machine dealing on the video-screen between two and five five-card hands from the same 52-card poker deck;
C. Determining the poker hand ranking of each one of the five-card hands;
D. If any of the five-card hands is a winning combination, awarding the player a pre-established winning amount based on the amount of the wager for each five-card hand;
E. The machine dealing, as incentive, only for each five-card winning combination, another five-card hand from the same original 52-card poker deck;
F. If any of the latest dealt five-card hands is a winning combination, awarding the player a pre-established winning amount based on the amount of the original wager for the corresponding original five-card hand;
G. If there is available a five-card hand from the same original 52-card poker deck, and if there is a five-card winning combination, steps E. and F. are repeated successively until the game ends;
Wherein, the game ends when there are no more available five-card hands from the same original 52-card poker deck.

13. The method of claim 11, wherein the game is played on a table and the five-card hands are dealt by a dealer.
